(19) United States
(12) Patent Application Publication
(10) Pub. No.: US 2017/0177656 A1
(43) Pub. Date: Jun. 22, 2017

(54) SYSTEMS AND METHODS FOR RESOLVING DATA DISCREPANCY

(71) Applicant: Wal-Mart Stores, Inc., Bentonville, AR (US)

(72) Inventors: Christopher Soames Johnson, Pea Ridge, AR (US); Cathy Gibbs, Bentonville, AR (US); Jimmie Russell Clark, Fayetteville, AR (US)

(21) Appl. No.: 15/381,480

(22) Filed: Dec. 16, 2016

Related U.S. Application Data
(60) Provisional application No. 62/269,771, filed on Dec. 18, 2015.

(51) Int. Cl. G06F 17/30

(52) U.S. Cl. CPC G06F 17/30371; G06F 17/30864

(57) ABSTRACT

Exemplary embodiments are provided for resolving data discrepancies. A request for resolution of data discrepancy is generated at a terminal in response to a difference between a first data value and a second data value. A server determines whether the difference between the first data value and the second data value is within a pre-defined threshold. When the difference is within the threshold, a message is transmitted to use the second data value. When the difference is not within the threshold, a message is transmitted to hand held devices to resolve the discrepancy. The hand held devices transmit a message including instructions on how to resolve the data discrepancy. The server transmits the instructions to the terminal to resolve the data discrepancy.

### RELATED APPLICATION

This application claims priority to U.S. Provisional Patent Application No. 62/269,771 filed on Dec. 18, 2015, which is hereby incorporated by reference in its entirety.

### BACKGROUND

Data discrepancies often arise in computing system where the data is being accessed and/or modified by one or more devices and/or where reliance on the data may be inappropriate due to human error. Typically data discrepancies are resolved by requiring a user to pause his or her activities while she or he or someone else investigates the discrepancy in data to identify a resolution to the discrepancy. The process for resolving such data discrepancies can be inefficient and require significant resources and time.

### SUMMARY

Exemplary embodiments of the present disclosure provide systems, methods, and computer readable medium for resolving data discrepancies.

In accordance with the present disclosure, a system for resolving data discrepancies is disclosed. The system includes a terminal comprising first and second input devices, a server in communication with the terminal via a first communication channel, and a plurality of hand held devices in communication with the server via a second communication channel. The terminal is configured to retrieve a first data value from a database in response to receipt of identifying information from the first input device, generate a request for resolution of a data discrepancy, the data discrepancy arising in response to a difference between a second data value received via the second input device and the first data value, and automatically transmit a first message including the first data value, the second data value, and the identifying information to the server via the first communication channel. The server is configured to programmatically determine whether the difference between the first and second data values is within a pre-defined threshold determined based on the identifying information. In response to the difference between the first and second data values being within the pre-defined threshold, the server is configured to generate and transmit a second message to the terminal via the first communication channel. The second message includes instructions that the terminal use the second data value despite the data discrepancy. In response to the difference between the first and second data values exceeding the pre-defined threshold, the server is configured to generate and transmit a third message to at least a subset of the hand held devices via the second communication channel for resolution of the data discrepancy, receive a fourth message from at least one of the hand held devices via the second communication channel, the fourth message including instructions for resolving the data discrepancy, and forward the instructions for resolving the data discrepancy via the first communication channel to the terminal. Upon receipt of the instructions for resolving the data discrepancy, resolves the data discrepancy locally at the terminal.

Additional combinations or permutations of the above examples are envisioned as being within the scope of the present disclosure. It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF DRAWINGS

The accompanying drawings, which are incorporated in and constitute a part of this specification, illustrate one or more embodiments of the invention and, together with the description, help to explain the invention. The embodiments are illustrated by way of example and should not be construed to limit the present disclosure. In the drawings:

FIG. 1 is a block diagram showing a discrepancy resolution system implemented in modules, according to an example embodiment;

FIG. 2 is a flowchart showing an exemplary method for resolving data discrepancies, according to an example embodiment;

FIG. 3 is a flowchart showing an exemplary method for resolving data discrepancies, according to an example embodiment;

FIG. 4 illustrates a network diagram depicting a system for implementing the discrepancy resolution system, according to an example embodiment; and

FIG. 5 is a block diagram of an exemplary computing device that can be used to implement exemplary embodiments of the discrepancy resolution system described herein.

### DESCRIPTION OF EXEMPLARY EMBODIMENTS

Exemplary embodiments of the present disclosure provide systems, methods and non-transitory computer readable medium for resolving data discrepancies via a discrepancy resolution system. Data discrepancies are often experienced when there exists two values for a single data value. Such data discrepancies often must be resolved before further data can be examined, processed, and/or utilized within a computing system. For example, a terminal can access a first value for a data value from a database (e.g., in response to user interaction with the terminal) and can obtain or enter a second value for the data value (e.g., based on an interaction with a source other than the database (e.g., from another a user who believes his or her data value as the accurate one, from a printed or physically expressed manifestation of the data value, from another database, and the like). While resolution of such discrepancies conventionally required that the terminal pause any analysis and processing of data until the discrepancy is resolved, embodiments of a discrepancy resolution system described herein can automatically and locally resolve a data discrepancy in the background while the user continues examining, processing, and/or utilizing additional data. Once the data discrepancy is resolved, the resolution can automatically be applied and any data referencing or depending on the resolution can be updated and/or adjust.

In some embodiments, the discrepancy resolution system includes a terminal, a server, and multiple hand held devices. The terminal may be programmed to process and analyze various data to achieve a particular output or goal as defined by the program instructions stored at the terminal. The terminal also includes multiple input devices, for example, keyboard(s), data scanning device(s), touch screens. The server is in communication with the terminal via a first communication channel, and the hand held devices are in communication with the server via a second communication channel.

The terminal receives identifying information from an input device, and in response, is configured to retrieve a first data value from a database. The terminal receives a second data value from an input device (e.g., from the same input device with which the identifying information is retrieved or from a different input device), and generates a request for resolution of a data discrepancy when a difference between the second data value and the first data value is realized by the terminal. The terminal automatically transmits the request to the server via the first communication channel and the server coordinates the resolution of the data discrepancy while the terminal can allow one or more users to interact with it.

The server is configured to programmatically determine whether the difference between the first and second data value is within a threshold, where the threshold is determined based on identifying information received by the terminal. When the difference is within the threshold, the server generates and transmits a message to the terminal to use the second data value while executing instructions stored at the terminal, despite the discrepancy between the first and second data values. In exemplary embodiments, the first value stored in the database is not updated by the server when the difference is within the threshold.

When the difference is not within the threshold, the server generates and transmits a message to at least a subset of the hand held devices via the second communication channel. The server receives another message from at least one of the hand held devices via the second communication channel, where the message includes instructions on resolving the data discrepancy. The server transmits the instructions to the terminal, and the terminal automatically and locally resolves the data discrepancy. In exemplary embodiments, the first value stored in the database can be updated by the server when the difference is not within the threshold.

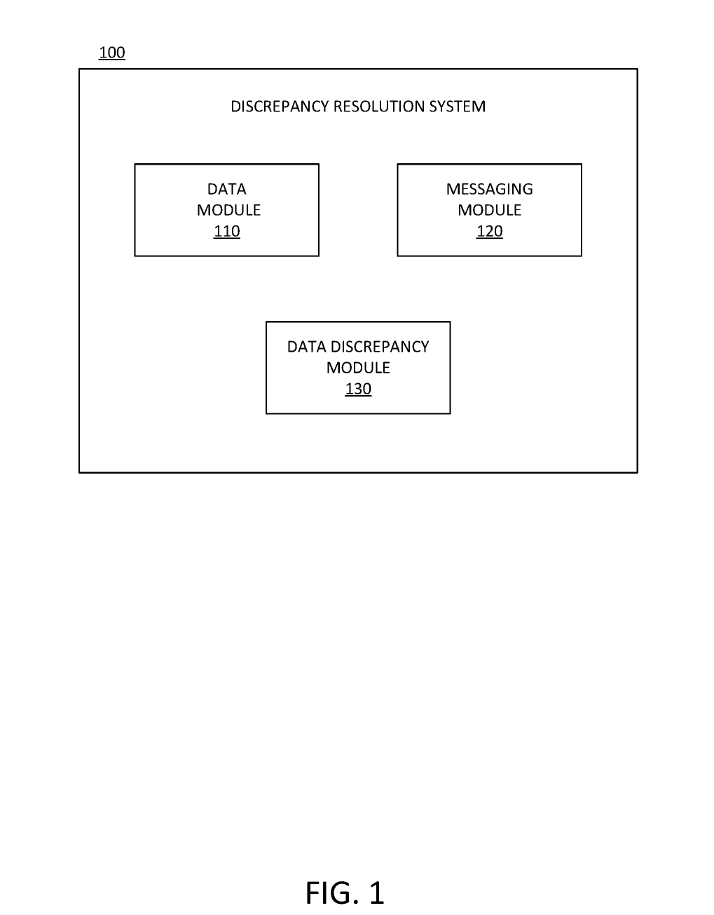

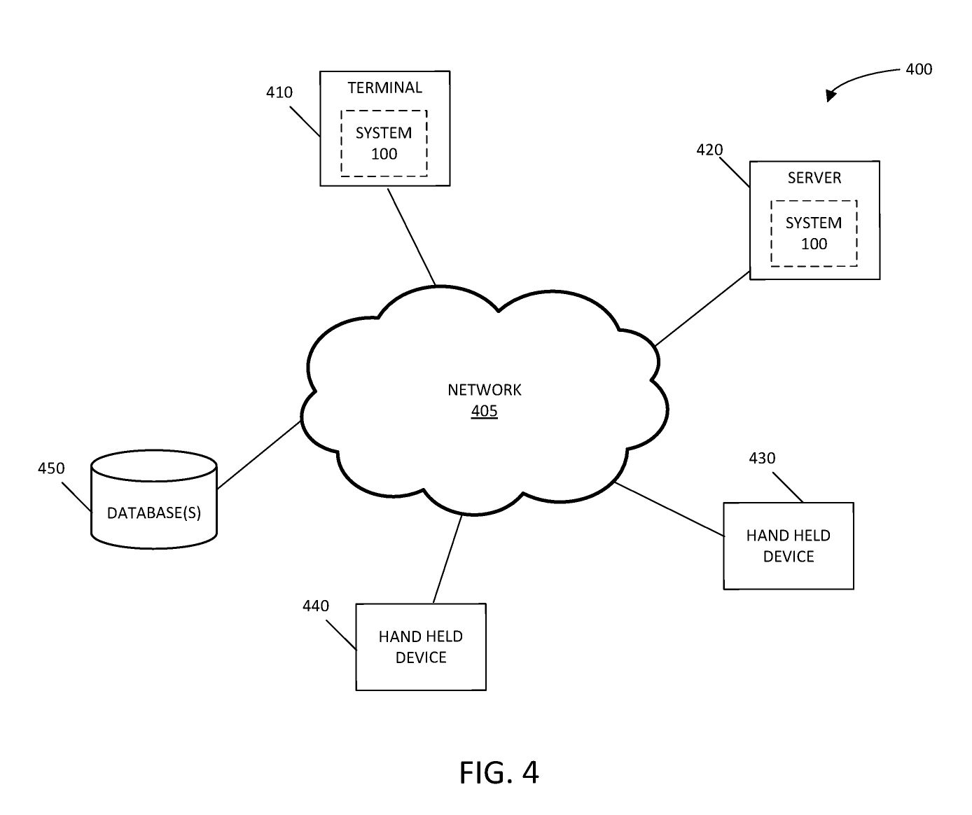

FIG. 1 is a block diagram 100 showing a discrepancy resolution system in terms of modules according to an example embodiment. In an example embodiment, the modules may be implemented in terminal 410 and/or server 420 shown in FIG. 4. The modules include a data module 110, messaging module 120, and a data discrepancy module 130. The modules may include various circuits, circuitry and one or more software components, programs, applications, or other units of code base or instructions configured to be executed by one or more processors included in terminal 410. In other example embodiments, one or more of modules 110, 120, 130 may be included in server 420 and/or hand held devices 430, 440, while other of the modules 110, 120, 130 are provided in the terminal 410. Although modules 110, 120, and 130 are shown as distinct modules in FIG. 1, it should be understood that modules 110, 120, and 130 may be implemented as fewer or more modules than illustrated. It should be understood that any of modules 110, 120, and 130 may communicate with one or more components included in system 400 (FIG. 4), such as terminal 410, server 420, hand held device 430, hand held device 440, or database(s) 450.

The data module 110 may be configured to receive identifying information (e.g., a unique identifier) from an input device that can be utilized to retrieve data from a database. For example, the identifying information can be read from a physical manifestation by the input device, such as a machine-readable identifier and/or a user can enter the identifying information via the input device. The data module 110 analyze and retrieve a first data value associated with the identifying information from a database. The data module 110 can also receive a second data value from the input device, or from a different input device. The second data value can be received for association with the identifying information, and the first and second data values can conflict such that a data discrepancy between the first and second data values can exist.

The messaging module 120 may be configured to generate, maintain, transmit, and analyze requests and messages (e.g., a first message, a second message, a third message, a fourth message, and so on). For example, in response to a determination that a data discrepancy exists between the first and second data values, the messaging module can be configured to generate, maintain, transmit, and/or analyze one or more messages. The messaging module 120 may be configured to receive and transmit messages between various components of the discrepancy resolution system, for example, terminals, servers, and hand held devices, as described herein. The messaging module 120 may also be configured to manage communication channels between various components of the discrepancy resolution system.

The data discrepancy module 130 may be configured to analyze data values with respect to thresholds, and resolve discrepancies in data. For example, the data discrepancy module 130 can determine whether to update a database to overwrite a data value with another data value, and/or to instruct a terminal to use a data value that is inconsistent with a corresponding data value stored in the database.

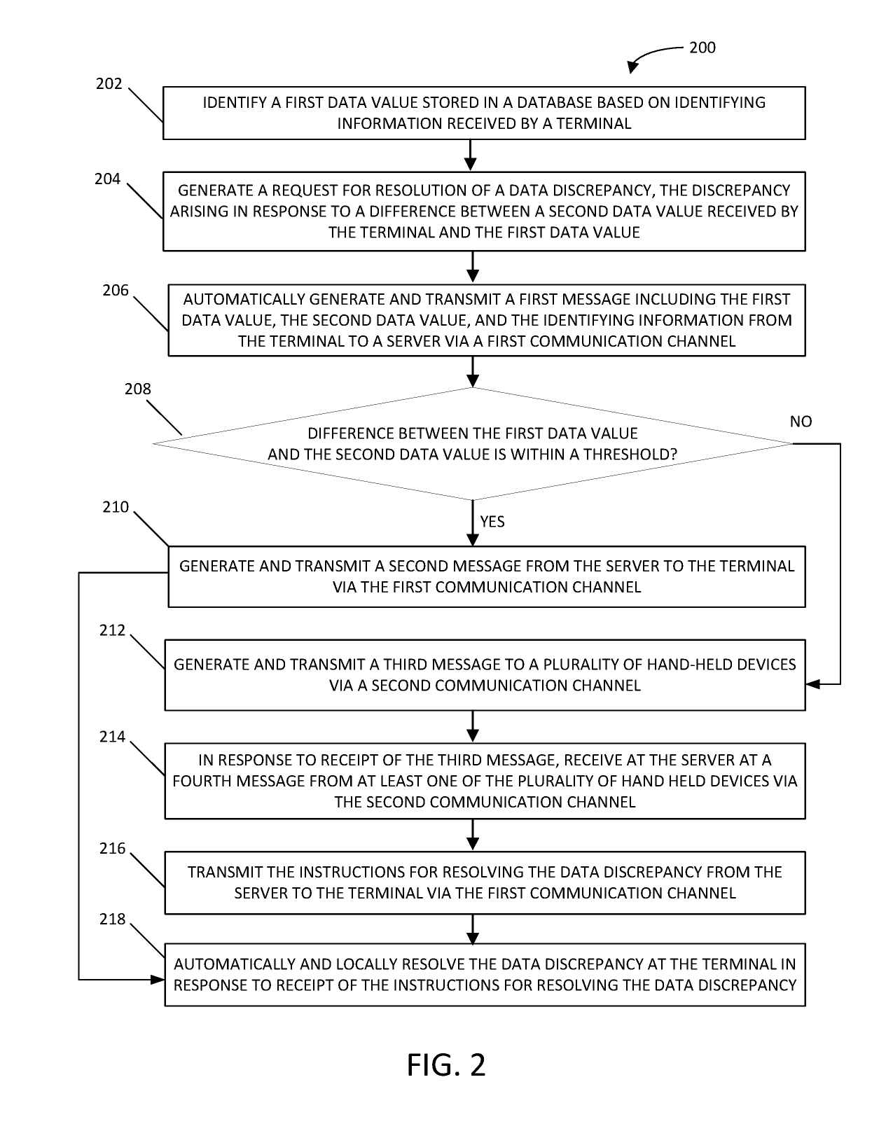

FIG. 2 is a flowchart showing an exemplary method for resolving data discrepancies, according to an example embodiment. The method 200 may be performed using the modules in the discrepancy resolution system 100 shown in FIG. 1 and the components described with reference to FIG. 4.

At step 202, the data module 110 identifies a first data value stored in a database based on identifying information received by a terminal (for example, from an input device associated with terminal 410 shown in FIG. 4).

At step 204, the messaging module 120 generates a request for resolution of a data discrepancy, where the data discrepancy arises when a difference exists between the first data value and a second data value received by the terminal for association with the identifying information. The data module 110 may receive a second data value via an input device associated with the terminal. The discrepancy resolution module 130 may determine that a difference exists between the first data value and the second data value.

At step 206, the messaging module 120 automatically generates and transmits a first message to a server via a first communication channel. The first message includes the first data value, the second data value and the identifying information received by the terminal. In an example embodiment, the server stores the data discrepancy between the first data value and the second data value in a discrepancy database, and associates the data discrepancy with the identifying information received by the terminal.

At step 208, the data discrepancy module 130 programmatically determines at the server whether a difference between the first data value and the second data value is within a (pre-defined) threshold. In an example embodiment, the threshold can be a maximum difference between the first data value and the second data value. In another example embodiment, the threshold can be a percentage of the first data value.

If the difference is within the threshold, then at step 210, the messaging module 120 generates and transmits a second message from the server to the terminal via the first communication channel. The second message may include instructions for resolving the data discrepancy using the second data value despite of the data discrepancy because the difference is within a threshold. The method 200 then continues to step 218, where the data discrepancy module 130 automatically and locally, at the terminal, resolves the data discrepancy in response to receipt of the instructions (e.g., via the second message). In this case, the terminal uses the second data value (rather than the first data value) while executing program instructions stored at the terminal to process and analyze various data.

If the difference between the first data value and the second data value is not within the threshold (step 208), then at step 212, the messaging module 120 generates and transmits a third message to multiple hand held devices via a second communication channel.

At step 214, the messaging module 120 receives at the server a fourth message from at least one of the multiple hand held devices via the second communication channel, in response to receipt of the third message by the hand held devices. The fourth message includes instructions for resolving the data discrepancy. In some embodiments, the fourth message includes instructions indicating that the second data value is accurate. In this case, the server may modify or replace the first data value in the database with the second data value, thus, correcting the data discrepancy in the database. In other embodiments, the fourth message includes instructions indicating that the first data value is accurate. In this case, the server takes no action with respect to the first data value. In other embodiments, the fourth message includes instructions indicating that a third data value is accurate. In this case, the server may modify or replace the first data value in the database with the third data value provided in the fourth message. In an example embodiment, the server does not modify the first data value in the database, thus, the data discrepancy between the first data value in the database and the second data value received at the terminal continues to exist, but the terminal is instructed to utilize one of the first or second data values despite the continued discrepancy. In an example embodiment, the server is configured to automatically transmit a request to the multiple hand held devices to perform one or more operations based on the data discrepancy and/or the resolution of the data discrepancy.

At step 216, the data discrepancy module 130 transmits the instructions for resolving the data discrepancy included in the fourth message from the server to the terminal via the first communication channel. The data discrepancy module 130 may generate and transmit a fifth message that includes the instructions for resolving the data discrepancy.

At step 218, the data discrepancy module 130 automatically and locally, at the terminal, resolves the data discrepancy in response to receipt of the instructions for resolving the data discrepancy (e.g., via the fourth message). In some embodiments, the fourth message includes instructions indicating that the second data value is accurate. In this case, the terminal uses the second data value while executing program instructions stored at the terminal to process and analyze various data. In other embodiments, the fourth message includes instructions indicating that the first data value is accurate. In this case, the terminal uses the first data value while executing program instructions stored at the terminal to process and analyze various data.

In an example embodiment, the server stores the data discrepancy between the first data value and the second data value in a discrepancy database, and associates the data discrepancy with the identifying information received by the terminal. In some embodiments, the server is configured to query the discrepancy database to determine whether previous data discrepancies were recorded for the identifying information received by the terminal, and whether they involved the first data value and the second data value. If the server determines that such previous data discrepancies exist, then the server transmits previously generated instructions for resolving the data discrepancy to the terminal. In this manner, the server can efficiently transmit instructions to resolve data discrepancies based on determining that such a data discrepancy was recorded or realized previously, and can instruct the terminal to take the same actions has taken in the previous case without requiring the system to re-evaluate the data discrepancy (e.g., determining whether the difference is within a threshold, transmitting messages to handheld devices, and the like); thereby reducing the quantity and utilization of resources in the system.

The terminal is configured to perform instructions stored therein to process and analyze various data to achieve an output or a goal. In some embodiments, the terminal is configured to continually process additional data while the server attempts to resolve the data discrepancy between the first data value and the second data value. This feature aids in efficient processing of data because the system does not need to stop processing additional data until the present data discrepancy is resolved. Using the data resolution system described herein, the terminal can continue to process additional data, while the server resolves the data discrepancy without requiring the terminal to pause.

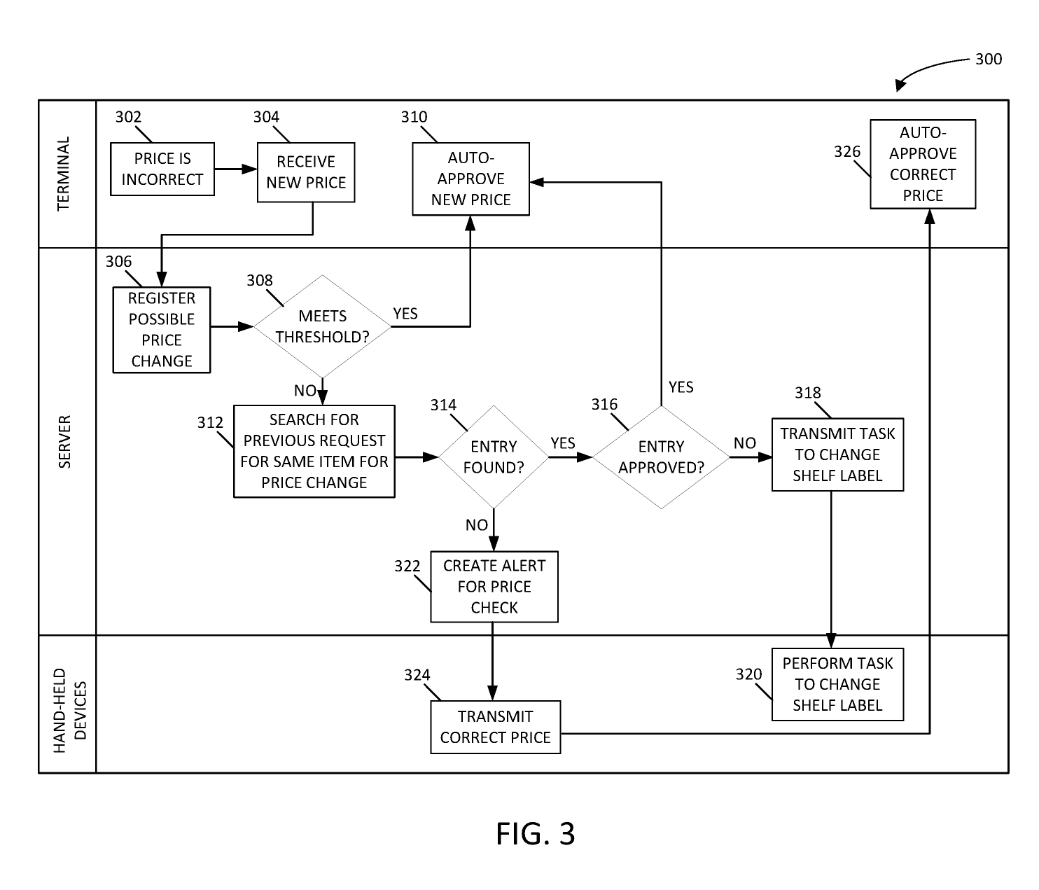

FIG. 3 is a flowchart showing an exemplary method 300 for resolving price data discrepancies, according to an example embodiment. In a non-limiting example, the data discrepancy system described herein can be used to resolve discrepancies in prices for items sold at a store. In this example, the terminal (e.g., terminal 410 shown in FIG. 4) may be programmed to function as a checkout device. The terminal may be used to retrieve a price of an item that a customer wishes to purchase from a database. For example, the terminal may include a scanner to scan a price tag or bar code on the item to obtain identifying information, which can be transmitted to a server to facilitate retrieval of the price for the item from the database. The price retrieved from the database may be the first data value. A user, for example, an associate of the store or a shopper, may enter another price value in the terminal, for example, the second data value. The discrepancy resolution system resolves the discrepancy between the two prices (the scanned price and the entered price) via the systems and methods described herein. The discrepancy is resolved at the terminal, and the resolved price is charged to the customer for the item.

For example, at block 302, the data module 110 receives a price for an item at the terminal, which may be an incorrect price (e.g., a first data value). At block 304, the data module 110 receives a new price at the terminal (e.g., a second data value). At block 306, the server registers a possible price change request.

The data discrepancy module 130, at block 308, determines whether the difference between the incorrect price (e.g., the first data value) and the new price (e.g., the second data value) meets a threshold. If the threshold is satisfied, the method 300 proceeds to block 310, where the new price (e.g., the second data value) is automatically approved, by the terminal, as the price for the item. If the threshold is not satisfied, the method moves to block 312. At block 312, the server searches for a previous request for a price change for the item. At block 314, if a previous price change request is found, the method proceeds to block 316. At block 316, the server determines whether the previous price request was approved. If the previous request was approved, the method 300 proceeds to block 310, where the terminal automatically approves the new price (e.g., the second data value).

If the previous request was not approved, the method 300 continues to block 318. At block 318, the server transmits a task to change the shelf label (for example, to update the price at the shelf for the item) to multiple hand held devices. The hand held devices may be devices assigned to or carried by associates in the store. At block 320, the hand held devices perform the task of changing the shelf label, for example, by printing a new label for the shelf that includes an updated price for the item.

Referring back to block 314, if the server determines that a previous request for a price change for the item is not found then the method 300 proceeds to block 322. At block 322, the server creates an alert for a price check and transmits it to the multiple hand held devices. At block 324, one or more of the hand held devices transmits a correct price for the item to the terminal. In some embodiments, the correct price for the item is the price initially received by the terminal (e.g., the first data value). In some embodiments, the correct price is the new price received by the terminal (e.g., the second data value). In other embodiments, the correct price may be different than the initial price received by the terminal and the new price received by the terminal (e.g., a third data value).

At block 326, the terminal automatically approves the correct price transmitted by the hand held devices. In an example embodiment, when the terminal automatically approves a price (at block 310 or block 326), the terminal automatically calculates a transaction total for a customer using the automatically approved price.

In this manner, in a non-limiting example, the discrepancy resolution system described herein can be used to automatically resolve data discrepancies in a retail environment, without an employee having to pause a checkout process. In conventional methods, the employee often pauses the checkout process and has to wait for a manager to approve a price a discrepancy for an item. Using the discrepancy resolution system described herein, the employee can continue with the checkout process, while the system (e.g., the terminal, the server, and the hand held devices) performs various functions and automatically processes the price discrepancy.

The customer is satisfied with an efficient checkout process, and the department manager or department associates are alerted of the discrepancy via the hand held devices. Depending on the price discrepancy the system either automatically approves the difference in price in the customer's favor and then alerts the department manager or department associates of the price change as a task to be rectified. If the price discrepancy is greater than a given amount or percentage then the system alerts the department manager or department associates for a price check within their hand held devices, and generate a price change task based on the correct price.

FIG. 4 illustrates a network diagram depicting a system 400 for implementing the discrepancy resolution system, according to an example embodiment. The system 400 can include a network 405, terminal 410, server 420, multiple hand held devices, for example, hand held device 430 and hand held device 440, and database(s) 450. Each of components 410, 420, 430, 440, and 450 is in communication with the network 405.

In an example embodiment, one or more portions of network 405 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

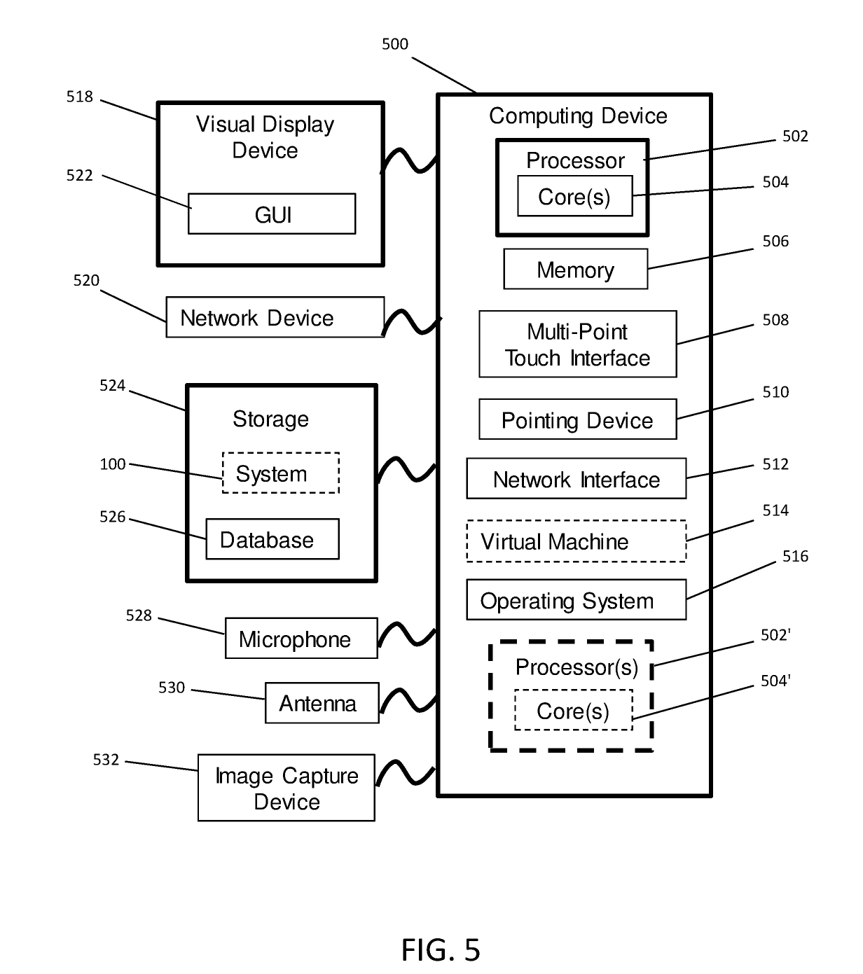

The terminal 410 may comprise, but is not limited to, work stations, computers, general purpose computers, Internet appliances, hand held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, mini-computers, and the like. The terminal 410 can include one or more components described in relation to computing device 500 shown in FIG. 5.

In the non-limiting example discussed in connection with FIG. 3, the terminal 410 may be part of a store infrastructure and aid in performing various transactions related to sales and other aspects of a store. Being part of a store's infrastructure, the terminal 410 may be installed within the store or they may be installed or operational outside of the store. For example, the terminal 410 may be a mobile device that a store employee can use outside of the store to perform transactions or other activities. In another example, the terminal 410 may be a kiosk installed outside the store. Similarly, the terminal 410 may be a mobile device that can be used within the store, and is not physically installed or attached to one particular location within the store. The terminal 410 may also include various external or peripheral devices to aid in performing transactions and other duties. Examples of peripheral devices include, but are not limited to, barcode scanners, cash drawers, monitors, touch-screen monitors, clicking devices (e.g., mouse), input devices (e.g., keyboard), receipt printers, coupon printers, payment terminals, and the like.

The terminal 410 may connect to network 405 via a wired or wireless connection. The terminal 410 may include one or more applications such as, but not limited to, a communication application, a database access application, and a discrepancy resolution system described herein.

Each of hand held device 430 and the hand held device 440 may comprise, but is not limited to, computers, Internet appliances, wireless devices, portable devices, wearable computers, cellular or mobile phones, portable digital assistants (PDAs), smart phones, tablets, ultrabooks, netbooks, laptops, multi-processor systems, microprocessor-based or programmable consumer electronics, mini-computers, and the like. The hand held device 430, 440 can include one or more components described in relation to computing device 500 shown in FIG. 5.

In an example embodiment, the terminal 410 may perform all the functionalities described herein. In other embodiments, the discrepancy resolution system may be included on the terminal 410, and the server 420 and/or the hand held devices 430, 440 perform the functionalities described herein. In yet another embodiment, the terminal 410 may perform some of the functionalities, and the server 420 and/or the hand held devices 430, 440 perform the other functionalities described herein.

Each of the server 420, hand held devices 430, 440 and the database(s) 450 is connected to the network 405 via a wired connection. Alternatively, one or more of the server 420, hand held devices 430, 440 and the database(s) 450 may be connected to the network 405 via a wireless connection. The server 420 comprises one or more computers or processors configured to communicate with the terminal 410, hand held devices 430, 440, and database(s) 450 via network 405. The server 420 hosts one or more applications or websites accessed by the terminal 410 and the hand held devices 430, 440 and/or facilitates access to the content of database(s) 450. Database(s) 450 comprise one or more storage devices for storing data and/or instructions (or code) for use by the terminal 410, the server 420, and the hand held devices 430, 440. The database(s) 450, and/or the server 420, may be located at one or more geographically distributed locations from each other or from the terminal 410 and the hand held devices 430, 440. Alternatively, the database(s) 450 may be included within the server 420.

FIG. 5 is a block diagram of an exemplary computing device 500 that may be used to implement exemplary embodiments of the discrepancy resolution system 100 described herein. The computing device 500 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 506 included in the computing device 500 may store computer-readable and computer-executable instructions or software for implementing exemplary embodiments of the discrepancy resolution system 100. The computing device 500 also includes configurable and/or programmable processor 502 and associated core 504, and optionally, one or more additional configurable and/or programmable processor(s) 502′ and associated core(s) 504′ (for example, in the case of computer systems having multiple processors/cores), for executing computer-readable and computer-executable instructions or software stored in the memory 506 and other programs for controlling system hardware. Processor 502 and processor(s) 502′ may each be a single core processor or multiple core (504 and 504′) processor.

Virtualization may be employed in the computing device 500 so that infrastructure and resources in the computing device may be shared dynamically. A virtual machine 514 may be provided to handle a process running on multiple processors so that the process appears to be using only one computing resource rather than multiple computing resources. Multiple virtual machines may also be used with one processor.

Memory 506 may include a computer system memory or random access memory, such as DRAM, SRAM, EDO RAM, and the like. Memory 506 may include other types of memory as well, or combinations thereof.

A user may interact with the computing device 500 through a visual display device 518, such as a computer monitor, which may display one or more graphical user interfaces 522 that may be provided in accordance with exemplary embodiments. The computing device 500 may include other I/O devices for receiving input from a user, for example, a keyboard or any suitable multi-point touch interface 508, a pointing device 510 (e.g., a mouse), a microphone 528, and/or an image capturing device 532 (e.g., a camera or scanner). The multi-point touch interface 508 (e.g., keyboard, pin pad, scanner, touch-screen, etc.) and the pointing device 510 (e.g., mouse, stylus pen, etc.) may be coupled to the visual display device 518. The computing device 500 may include other suitable conventional I/O peripherals.

The computing device 500 may also include one or more storage devices 524, such as a hard-drive, CD-ROM, or other computer readable media, for storing data and computer-readable instructions and/or software that implement exemplary embodiments of the discrepancy resolution system 100 described herein. Exemplary storage device 524 may also store one or more databases for storing any suitable information required to implement exemplary embodiments. For example, exemplary storage device 524 can store one or more databases 526 for storing information, such the first data value, the second data value, the pre-defined threshold, and/or any other information to be used by embodiments of the system 100. The databases may be updated manually or automatically at any suitable time to add, delete, and/or update one or more items in the databases.

The computing device 500 can include a network interface 512 configured to interface via one or more network devices 520 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. In exemplary embodiments, the computing device 500 can include one or more antennas 530 to facilitate wireless communication (e.g., via the network interface) between the computing device 500 and a network. The network interface 512 may include a built-in network adapter, network interface card, PCMCIA network card, card bus network adapter, wireless network adapter, USB network adapter, modem or any other device suitable for interfacing the computing device 500 to any type of network capable of communication and performing the operations described herein. Moreover, the computing device 500 may be any computer system, such as a workstation, desktop computer, server, laptop, handheld computer, tablet computer (e.g., the iPad™ tablet computer), mobile computing or communication device (e.g., the iPhone™ communication device), point-of sale terminal, internal corporate devices, or other form of computing or telecommunications device that is capable of communication and that has sufficient processor power and memory capacity to perform the operations described herein.

The computing device 500 may run any operating system 516, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 516 may be run in native mode or emulated mode. In an exemplary embodiment, the operating system 516 may be run on one or more cloud machine instances.

The following description is presented to enable any person skilled in the art to create and use a computer system configuration and related method and article of manufacture to resolve data discrepancies. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A system for resolving data discrepancies, the system comprising:
(a) a terminal comprising first and second input devices;
(b) a server in communication with the terminal via a first communication channel; and
(c) a plurality of hand held devices in communication with the server via a second communication channel;
(d) wherein the terminal is configured to:
(i) retrieve a first data value from a database in response to receipt of identifying information from the first input device,
(ii) generate a request for resolution of a data discrepancy, the data discrepancy arising in response to a difference between a second data value received via the second input device and the first data value,
(iii) automatically transmit a first message including the first data value, the second data value, and the identifying information to the server via the first communication channel,
(e) wherein the server is configured to programmatically determine whether the difference between the first and second data values is within a pre-defined threshold determined based on the identifying information,
(f) wherein, in response to the difference between the first and second data values being within the pre-defined threshold, the server is configured to: (i) generate and transmit a second message to the terminal via the first communication channel, the second message including instructions that the terminal use the second data value despite the data discrepancy, and
(g) wherein, in response to the difference between the first and second data values exceeding the pre-defined threshold, the server is configured to:
(i) generate and transmit a third message to at least a subset of the hand held devices via the second communication channel for resolution of the data discrepancy,
(ii) receive a fourth message from at least one of the hand held devices via the second communication channel, the fourth message including instructions for resolving the data discrepancy, and
(iii) forward the instructions for resolving the data discrepancy via the first communication channel to the terminal, which upon receipt of the instructions for resolving the data discrepancy, resolves the data discrepancy locally at the terminal.

2. The system of claim 1, wherein, in response to the fourth message from the at least one of the hand held devices via the second communication channel, the server modifies the first data value in the database to be the second data value.

3. The system of claim 1, wherein, in response to the fourth message from the at least one of the hand held devices via the second communication channel, the first data value in the database is not modified by the server such that the data discrepancy still exists between the first data value in the database and the second data value input to the terminal.

4. The system of claim 1, wherein the terminal is configured to continually process additional data while the server attempts to resolve the data discrepancy.

5. The system of claim 1, wherein the server is configured to store the data discrepancy between the first data value and the second data value in a discrepancy database.

6. The system of claim 5, wherein the server is further configured to:
query the discrepancy database to determine whether previous data discrepancies between the first data value and the second data value exist;
in response to determining previous data discrepancies exist, transmitting previously generated instructions for resolving the data discrepancy from the server to the terminal in response to another occurrence of the data discrepancy.

7. The system of claim 1, wherein the server is further configured to automatically request that the hand held devices perform one or more operations in response to the data discrepancy.

8. The system of claim 1, wherein the pre-defined threshold is a maximum difference between the first data value and the second data value.

9. The system of claim 1, wherein the pre-defined threshold is a percentage of the first data value.

10. A method for resolving data discrepancies in a distributed computing system, the method comprising:
identifying a first data value stored in a database based on identifying information received by a terminal;
generating a request for resolution of a data discrepancy, the data discrepancy arising in response to a difference between a second data value received by the terminal and the first data value;
automatically generating and transmitting a first message including the first data value, the second data value, and the identifying information from the terminal to a server via a first communication channel;
programmatically determining at the server whether a difference between the first data value and the second data value is within a pre-defined threshold determined based on the identifying information;
in response to the difference between the first data value and the second data value being within the pre-defined threshold, generating and transmitting a second message from the server to the terminal via the first communication channel, the second message including instructions that the terminal use the second data value despite the data discrepancy;
in response to the difference between the first data value and the second data value exceeding the pre-defined threshold, generating and transmitting a third message to a plurality of hand held devices via a second communication channel;
in response to receipt of the third message by plurality of hand held devices, receiving, at the server, a fourth message from at least one of the plurality of hand held devices via the second communication channel, the fourth message including instructions for resolving the data discrepancy;
transmitting the instructions for resolving the data discrepancy from the server to the terminal via the first communication channel; and
automatically and locally resolving the data discrepancy at the terminal in response to receipt of the instructions for resolving the data discrepancy.

11. The method of claim 10, wherein, in response to the fourth message from the at least one of the hand held devices via the second communication channel, modifying the first data value in the database to be the second data value.

12. The method of claim 10, wherein, in response to the fourth message from the at least one of the hand held devices via the second communication channel, the first data value in the database is not modified by the server such that the data discrepancy still exists between the first data value in the database and the second data value input to the terminal.

13. The method of claim 10, further comprising automatically requesting that the hand held devices perform one or more operations in response to the data discrepancy.

14. The method of claim 10, further comprising continually processing additional data at the terminal while the server attempts to resolve the data discrepancy.

15. The method of claim 10, further comprising storing the data discrepancy between the first data value and the second data value in a discrepancy database.

16. The method of claim 15, further comprising:
querying the discrepancy database to determine whether previous data discrepancies between the first data value and the second data value exist;
in response to determining previous data discrepancies exist, transmitting previously generated instructions for resolving the data discrepancy from the server to the terminal in response to another occurrence of the data discrepancy.

17. A non-transitory machine-readable medium storing instructions executable by a processing device, wherein execution of the instructions causes the processing device to implement a method for resolving data discrepancies in a distributed computing system, the method comprising:
identifying a first data value stored in a database based on the identifying information received by a terminal;
generating a request for resolution of a data discrepancy, the data discrepancy arising in response to a difference between a second data value received by the terminal and the first data value;
automatically generating and transmitting a first message including the first data value, the second data value, and the identifying information from the terminal to a server via a first communication channel;
programmatically determining at the server whether a difference between the first data value and the second data value is within a pre-defined threshold determined based on the identifying information;
in response to the difference between the first data value and the second data value being within the pre-defined threshold, generating and transmitting a second message from the server to the terminal via the first communication channel, the second message including instructions that the terminal use the second data value despite the data discrepancy;
in response to the difference between the first data value and the second data value exceeding the pre-defined threshold, generating and transmitting a third message to a plurality of hand held devices via a second communication channel;
in response to receipt of the third message by plurality of hand held devices, receiving, at the server, a fourth message from at least one of the plurality of hand held devices via the second communication channel, the fourth message including instructions for resolving the data discrepancy;
transmitting the instructions for resolving the data discrepancy from the server to the terminal via the first communication channel; and
automatically and locally resolving the data discrepancy at the terminal in response to receipt of the instructions for resolving the data discrepancy.

18. The non-transitory machine-readable medium of claim 17, wherein, in response to the fourth message from the at least one of the hand held devices via the second communication channel, modifying the first data value in the database to be the second data value.

19. The non-transitory machine-readable medium of claim 17, wherein, in response to the fourth message from the at least one of the hand held devices via the second communication channel, the first data value in the database is not modified by the server such that the data discrepancy still exists between the first data value in the database and the second data value input to the terminal.

20. The non-transitory machine-readable medium of claim 19, wherein the method comprises continually processing additional data at the terminal while the server attempts to resolve the data discrepancy.
